(19) United States
(12) Patent Application Publication
(10) Pub. No.: US 2011/0059824 A1
(43) Pub. Date: Mar. 10, 2011

(54) MODE CHANGING DEVICE FOR A POWER BRANCHING TRANSMISSION

(75) Inventors: Michel Buannec, Verneuil Sur Seine (FR); Paulo Da Silva, Suresnes (FR)

(73) Assignee: RENAULT S.A.S., BOULOGNE BILLANCOURT (FR)

(21) Appl. No.: 12/528,109

(22) PCT Filed: Feb. 12, 2008
(86) PCT No.: PCT/FR08/50208

§ 371 Date: Nov. 1, 2010

(30) Foreign Application Priority Data
Feb. 21, 2007 (FR) 0753409

(51) Int. Cl. F16H 3/78; F16H 3/44

(52) U.S. Cl. 475/303; 475/269; 475/320

(57) ABSTRACT

A device for changing the mode of a power-branching transmission, that includes a casing to be connected to the transmission, an epicyclic train with three inputs, a mechanism blocking a first input relative to the casing that can be selectively actuated to establish a first operation mode of the transmission, and a kinematic chain provided with a connection mechanism connecting the first input with a second input, when the connection mechanism is actuated, to establish a second operation mode of transmission. The kinematic chain includes at least one meshing between two gears.

The invention relates to the field of devices for changing transmission mode, particularly in power distribution transmissions for motor vehicles.

Application FR 2 859 669 (RENAULT) discloses a power distribution transmission connecting the combustion engine in parallel to the wheels of the vehicle using two mechanical power transmission paths. The transmission described comprises two electrical machines forming an electrical power transmission path by converting mechanical power into electrical power and vice versa. One of the mechanical power paths comprises a mode change device. This device comprises a mode change epicyclic geartrain in which two inputs of the epicyclic geartrain are inserted along said mechanical path. The third input to the mode change epicyclic geartrain is connected by a component either to another input or to the casing of the transmission. In one of the modes, the third input is connected to the casing so that the velocity ratio applied to the mechanical transmission path can be adjusted by varying the tooth sets of the mode change epicyclic geartrain. In the other mode, the third input is connected to another input of this same epicyclic geartrain so that the latter rotates en masse. The velocity ratio applied to the mechanical path is set at unity. The disadvantage with a mode change device such as this is that only one of the modes can be adjusted independently of the other.

The invention proposes a mode change device for a power distribution transmission and the corresponding transmission, which overcome the aforementioned disadvantages and which notably allow greater flexibility in adapting each of the transmission modes. According to one embodiment, the mode change device for a power distribution transmission comprises a casing intended to be fixed to the transmission, an epicyclic geartrain with three inputs, a blocking means for immobilizing a first input with respect to the casing, that can be actuated selectively in order to establish a first mode of operation of the transmission, and a drivechain equipped with a lock-up means which, when the lock-up means is actuated, connects the first input to a second input so as to establish a second mode of operation of the transmission. The drivechain comprises at least one intermeshing of two pinions.

The applicant has noticed that for each of the two modes of operation of the transmission, the proportion of power passing along the electrical path is at a minimum for a given range of transmission ratios. This range is the range in which the transmission exhibits the best energy efficiency. The applicant has particularly noticed that overall optimization of the transmission involves getting the optimum range of ratios for the second mode to follow on from the optimum range of ratios for the first mode. By virtue of the intermeshing ratio introduced in the drivechain between the two inputs of the mode change epicyclic geartrain, it is possible to adjust each of the modes independently of one another. That makes it possible, by acting on the two pinions of the drivechain, to modify the optimum range of the second mode in such a way that it follows on from the optimum range of ratios for the first mode, and to do so without having to alter the other parts of the transmission. That may make it possible, for example, for one and the same transmission to be adapted to suit various drives.

According to an alternative form, the first input of the epicyclic geartrain is a planet carrier and the second input is an annulus gear.

According to another alternative form, the lock-up means comprises a dog-type synchronizer.

According to one embodiment, the synchronizer is coaxial with the epicyclic geartrain.

According to another embodiment, the device comprises a countershaft on which there are mounted a first and a second intermediate pinion and the dog-type synchronizer able to lock the rotation of the two intermediate pinions; the first intermediate pinion meshing with a first main pinion that is fixed with respect to the first input; the second intermediate pinion meshing with a second main pinion that is fixed with respect to the second input. This drivechain has two successive intermeshings. That further improves the flexibility of the transmission. In addition, it allows the synchronizer, that has to be actuated by a fork, to be resited at a more accessible point in the transmission. This is particularly advantageous when the components mounted on the axis of the mode change epicyclic geartrain are of significant radial bulk which they are in transmissions mounted transversally in the vehicle, for example when a chain is fitted around the annulus gear of the mode change epicyclic geartrain.

Advantageously, the synchronizer comprises a body capable of translational movement and collaborating with longitudinal splines of the countershaft. The first intermediate pinion is mounted fixedly on the countershaft. That makes it possible to have a synchronizer that is particularly compact in a radial direction.

Advantageously, the synchronizer is able to synchronize the first intermediate pinion either with the casing alone, or with the casing and with the second intermediate pinion simultaneously, or with the second intermediate pinion alone. The transition between the two modes of operation of the transmission occurs when the mechanical path in which the mode change device is inserted has a zero velocity. The transmission ratio inserted in said mechanical path can then be changed without making the vehicle jolt. In addition, that makes it possible to switch from one transmission mode to the other without at any moment opening the mechanical power transmission path in which the mode change device is inserted.

According to an alternative form, the blocking means directly connects the first input to the casing in such a way that components contributing to the second mode actuating drivechain do not transmit torque when the first mode is actuated. The applicant company has noticed that the torque transmitted by the mechanical path in which the mode change device is inserted is lower in the second mode than in the first mode. Not using the second mode drivechain for the first mode allows the size of the components in this drivechain to be reduced. That for example makes it possible to reduce the diameter of the shafts or the width of the tooth sets, and to reduce the space occupied by the transmission.

Advantageously, the blocking means comprises a sliding gear, guided in axial translation in the casing, and a flange fixed to the first input. The sliding gear is equipped with lateral dogs able to collaborate with dogs belonging to the flange.

Advantageously, the blocking means can be actuated independently of the lock-up means. That makes it possible for the region of overlap between the two modes to be adjusted more simply, and that decreases the mechanical tolerances on the actuators.

Other features and advantages of the invention will emerge from reading the detailed description of a number of embodiments taken by way of nonlimiting examples and illustrated by the attached drawing in which:

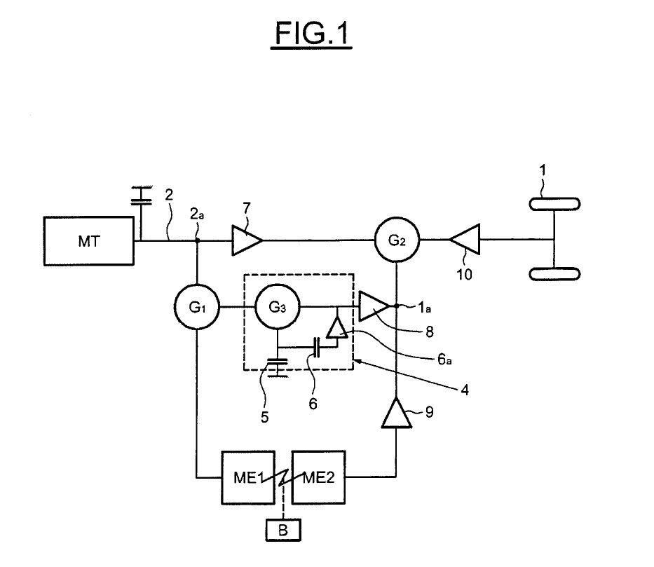

FIG. 1 is an overview of the power distribution transmission according to the invention;

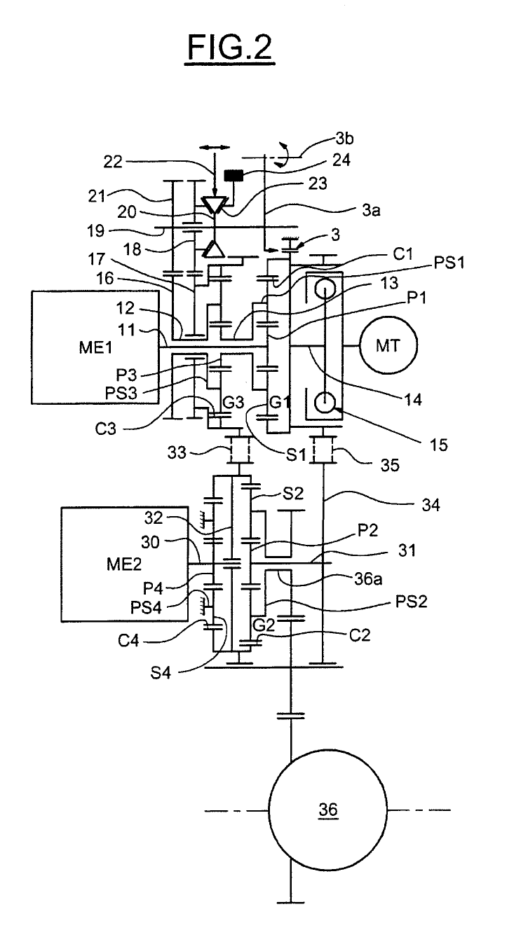

FIG. 2 is a detailed diagram of the transmission showing a device according to one embodiment of the invention;

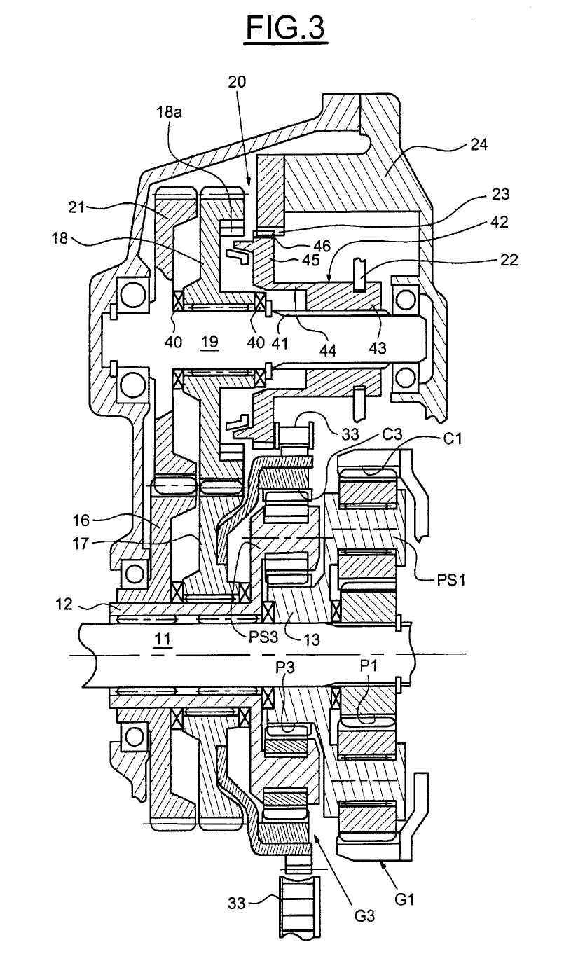

FIG. 3 is a longitudinal section through the device according to the embodiment of FIG. 2; and

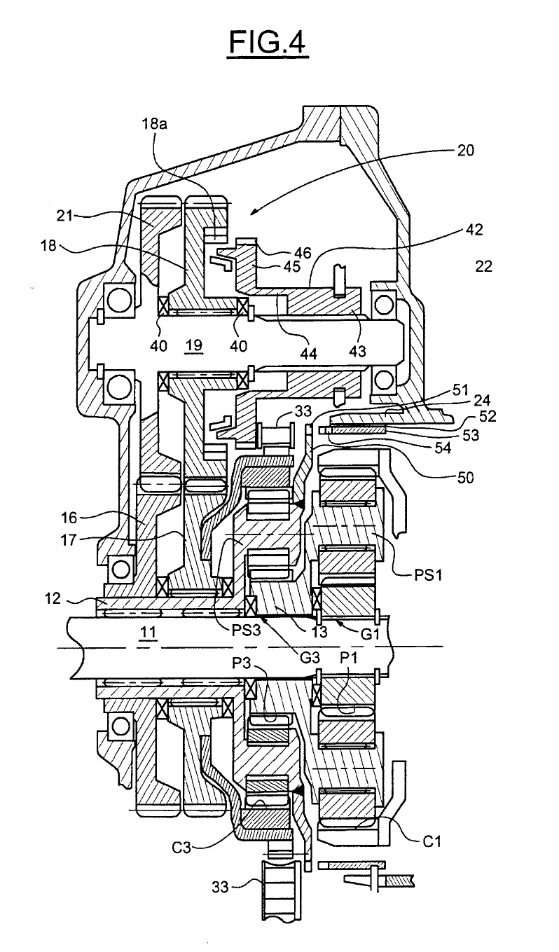

FIG. 4 is a longitudinal section through another embodiment of the invention.

As illustrated in FIG. 1, the power distribution transmission is connected to a combustion engine MT, to a first electrical machine ME1, to a second electrical machine ME2 and to wheels 1. The actual transmission proper comprises an input shaft 2, a first epicyclic geartrain G1, a second epicyclic geartrain G2 and a mode change device 4, which comprises a third epicyclic geartrain G3 together with a blocking means 5 and a lock-up means 6. The transmission also comprises four transmission devices 7, 8, 9 and 10 exhibiting a fixed transmission ratio and interposed between the second epicyclic geartrain G2 and, respectively, the combustion engine MT, the mode change device 4, the second electrical machine ME2 and the wheels 1. Another fixed ratio transmission device 6a is mounted in series with the lock-up means 6 between two inputs of the third epicyclic geartrain G3.

The torque transmitted to the input shaft 2 is split by a common rotation power combination device 2a, between the transmission device 7 and the first epicyclic geartrain G1. The driving torques from the transmission devices 8 and 9 are added together by a first common rotation power combination device 1a. The transmission has one power transmission electrical path and two power transmission mechanical paths. The electrical path comprises the electrical machines ME1 and ME2. A first mechanical path connects the first epicyclic geartrain G1 to the first common rotation power combination device 1a. A second mechanical path connects the second common rotation power combination device 2a to the second epicyclic geartrain G2.

The transmission works on a power distribution basis. The power of the combustion engine MT is transmitted to the wheels 1 via the mechanical paths and via the electrical path. When one of the machines ME1 or ME2 is operating as an alternator, the other is operating as a motor. The difference between the electrical energy supplied by the alternator and that consumed by the motor is stored or provided by a battery B of the vehicle.

When the blocking means 5 of the mode change device 4 is actuated and the lock-up means 6 is unlocked, the transmission ratio between the first epicyclic geartrain G1 and the transmission device 8 exhibits a fixed given ratio. This configuration corresponds to a first mode of operation of the transmission, suited to low vehicle speeds.

When the lock-up means 6 is actuated and the blocking means 5 is unblocked, the mode change device 4 exhibits another transmission ratio allowing the power distribution transmission to be operated in a way that is optimized for high vehicle speeds. The change in mode occurs when no mechanical power is passing through the mode change device 4, that is to say when the three inputs of the third epicyclic geartrain G3 are stationary. The mode change instant is not manifested by any vehicle torque change jolt. In addition, the change in mode may be effected using dog-type systems which have the advantage that they can be actuated mechanically and do not give rise to any dispersion of energy once they are in the engaged position.

All the gearings in the transmission are optimized so that, in the first mode of operation (blocking means 5 activated), the proportion of energy transmitted through the electrical path is minimal for a range of transmission ratios between the engine MT and the wheels M1 that correspond to low vehicle speeds. Thanks to this optimization, the transmission has an infinitely variable ratio while at the same time minimizing energy losses due to the conversion of mechanical energy into electrical energy and vice versa. The device 6a makes it possible to introduce a degree of freedom allowing the second mode of operation of the transmission to optimize the proportion of energy transmitted through the electrical path for a range of transmission ratios that is a continuous progression from the optimized range for the first mode. The presence of a transmission device with a fixed ratio 6a in the mode change device 4 allows the entire transmission to be optimized from an energy standpoint for a very wide range of transmission ratios.

FIG. 2 will now be used to describe in greater detail a particular structure that can be used to achieve a power distribution transmission corresponding to FIG. 1.

The transmission mainly comprises two axes, one comprising the combustion engine MT and the first electrical machine ME1 and the other comprising the second machine ME2. On the first axis, from left to right, the transmission comprises a drive shaft 11 for the first electrical machine ME1, about which there are mounted, so that they can rotate, a first hub 12 and a second hub 13. An input shaft 14 is equipped with a dynamic damper device 15, connected to the combustion engine MT in axial alignment with the drive shaft 11.

The first and third epicyclic geartrains G1, G3 are coaxial with the first axis. Each of the epicyclic geartrains G1, G3 comprises a sun gear P1, P3, planet pinions S1 and S3, a planet carrier PS1, PS3 and an annulus gear C1, C3. The first hub 12 is equipped with a fixed main pinion 16, with a free main pinion 17 and is fixed to the planet carrier PS3. The sun gear P3 and the planet carrier PS1 are fixed to the second hub 13. The free main pinion 17 is fixed to the annulus gear C3 and meshes with an intermediate pinion 18 mounted free to rotate on a countershaft 19. The countershaft 19 comprises a double dog-type synchronizer 20 and a fixed intermediate pinion 21 in a mesh with the fixed main pinion 16. The synchronizer 20 is able, under the action of a fork 22, to lock the fixed pinion 21 either to the intermediate pinion 18, or to dogs 23 that are fixed with respect to a casing 24 of the transmission.

The blocking means 5 consists of the main pinion 16, the intermediate pinion 18, the synchronizer 20 and the fixed dog 23.

A description of the second axis of the transmission will now be given. A drive shaft 30 for the second electrical machine ME2 and an intermediate shaft 31 are aligned with one another. Two coaxial epicyclic geartrains G2 and G4 respectively each comprise a sun gear P2, P4, planet pinions S2 and S4, a planet carrier PS2, PS4 and an annulus gear C2, C4. The sun gear P4 is mounted on the drive shaft 30. A wheel 32 mounted free to rotate comprises the annulus elements C4 and C2 and is connected to the annulus gear C3 in terms of rotation by a chain 33. The sun gear P2 is made to rotate by the intermediate shaft 31 and by a wheel 34 connected by a chain 35 to the annulus gear C1. The planet carrier PS2 is mounted on a hub 36a free to rotate about the intermediate shaft 31 and connected to the wheels via a differential 36.

The fixed-ratio transmission device 9 consists of the epicyclic geartrain G4 in which the planet carrier PS4 is fixed. That allows a transmission ratio to be introduced between the drive shaft of the second electrical machine ME2 and the annulus gear C2 of the second epicyclic geartrain G2.

The first common rotation power combination device 1a is a ternary device consisting of the annulus gear C2 made to rotate by the chain 33, the planets of the second and fourth epicyclic geartrains G2 and G4. The second common rotation power combination device 2a is a ternary device consisting of the annulus gear C1 made to rotate by the input shaft 14, the chain 33 and the planets of the first epicyclic geartrain G1. In an alternative form, any kind of common rotation power combination device would be suitable. All that is required is for this device to consist of a wheel made to rotate by at least three different rotational-drive means. The rotational speed is common to the three means and the sum of the torques exerted by the means on the common wheel is zero.

FIG. 3 will now be used to describe the space-saving advantage afforded by the fact that the synchronizer 20 is located on the countershaft 19 when the annulus gear C3 of the mode change epicyclic geartrain G3 has the chain 33 passing around it. Indeed, in the case of a transmission intended to be mounted transversally in a vehicle, the space requirement that needs to be optimized is the lengthwise size. FIG. 3 illustrates the fact that the function of synchronization between the planet carrier PS3 and the annulus gear C3 occupies, in the axial direction, only the width of the main pinions 16 and 17.

The intermediate pinion 19 is mounted on two rolling bearings in the casing 24. The free intermediate pinion 18 is blocked against translational movement along the countershaft 19 by axial thrust rolling bearings 40. The shaft 19 is equipped with longitudinal splines 41 that act as synchronizer bodies for the synchronizer 20. The synchronizer 20 has a sliding gear 42 which comprises a guide hub 43 collaborating directly with the splines 41 of the guide shaft 19. The sliding gear comprises a skirt 44 extending axially around the shaft 19 and connected at one end to a wheel 45 extending radially and at the other end to the guide hub 43. The wheel is equipped with a dog 46 able to collaborate either with dogs 18a of the free intermediate pinion 18 or with the dogs 23 fixed to the casing 24. The axial distance between the dogs 23 and 18a is less than the axial length of the dog 46.

During translational movement of the sliding gear 42, the dog 46 moves from a position in which it collaborates only with the fixed dog 23, as illustrated in FIG. 3, then into a common position in which the dog 46 collaborates simultaneously with the dogs 23 and 18a, then finally into a position in which the dog 46 collaborates only with the dog 18a. In the position of engagement with the pinion 18, the skirt 44 of the sliding gear 20 surrounds the axial thrust rolling bearing 40 and part of the hub of the pinion 18. Thanks to this arrangement of the skirt 44, the dogs 46 and 18a can have a diameter greater than the empty radial space between the chain 33 and the shaft 19. In addition, the skirt 44 allows the fork 22 to be able to move axially in an axial region situated on the other side of the chain 33 with respect to the intermediate pinion 18. Thus, a construction such as this allows simultaneously synchronizing between the planet carrier 3 and the annulus gear 3 needed for the mode change and introduction of a meshing ratio into the drivechain between these two elements, and does so while at the same time minimizing the axial space requirement and the additional radial space required.

FIG. 4 will now be used to describe an improvement to the previous device, in which the immobilizing device 5 can be actuated independently of the lock-up means 6, while at the same time retaining all of the abovementioned advantages. A flange 50 extends radially out from the planet carrier PS3 and is connected to that portion of the planet carrier PS3 that lies between the first and third epicyclic geartrains G1 and G3. The flange 50 at its periphery has dogs 51. A sliding gear 53 in the form of an annulus surrounds the annulus gear C1 of the first epicyclic geartrain G1. The sliding gear 53 has axial splines 52 collaborating with complementary splines belonging to the casing 24. The sliding gear 53 has dogs 54 extending laterally in the axial direction so that they can collaborate with the peripheral dogs 51 of the flange 50. The sliding gear 53 can be actuated by a system of forks, not depicted, situated in the same axial portion of the transmission as the forks 22, that is to say between the chains 33 and 35.

In an alternative form of embodiment, the sliding gears 53 and 42 are actuated not independently of one another but simultaneously by one and the same actuator. The fact of having moved the immobilizing means 5 upstream of the drivechain linking the planet carrier PS3 to the annulus gear C3 makes it possible to have main and intermediate pinions 16, 17, 18 and 21 with tooth set widths that are narrower, because they have a lower torque to transmit. In addition, the wheel 45 may also be narrower, because the dog 46 has to collaborate only with the dog 18a. These two factors make it possible further to reduce the axial size of the transmission.

1-10. (canceled)

11. A mode change device for a power distribution transmission, comprising:
a casing to be fixed to the transmission;
an epicyclic geartrain including three inputs;
a blocking means for immobilizing a first input with respect to the casing, that can be actuated selectively to establish a first mode of operation of the transmission; and
a drivechain including a lock-up means which, when the lock-up means is actuated, connects the first input to a second input so as to establish a second mode of operation of the transmission,
wherein the drivechain comprises at least one intermeshing of two pinions.

12. The device as claimed in claim 11, in which a first input of the epicyclic geartrain is a planet carrier and a second input is an annulus gear.

13. The device as claimed in claim 11, in which the lock-up means comprises a dog-type synchronizer.

14. The device as claimed in claim 13, in which the synchronizer is coaxial with the epicyclic geartrain.

15. The device as claimed in claim 13, further comprising a countershaft on which there are mounted a first and a second intermediate pinion and the dog-type synchronizer to lock the rotation of the two intermediate pinions; the first intermediate pinion meshing with a first main pinion that is fixed with respect to the first input; the second intermediate pinion meshing with a second main pinion that is fixed with respect to the second input.

16. The device as claimed in claim 15, in which the synchronizer comprises a sliding gear configured for translational movement and collaborating with longitudinal splines of the countershaft; the first intermediate pinion being mounted fixedly on the countershaft.

17. The device as claimed in claim 16, in which the synchronizer is configured to synchronize the first intermediate pinion either with the casing alone, or with the casing and with the second intermediate pinion simultaneously, or with the second intermediate pinion alone.

18. The device as claimed in claim 11, in which the blocking means directly connects the first input to the casing such that components contributing to the second mode actuating drivechain do not transmit torque when the first mode is actuated.

19. The device as claimed in claim 18, in which the blocking means comprises a sliding gear, guided in axial translation in the casing, and a flange fixed to the first input; the sliding gear including lateral dogs to collaborate with dogs belonging to the flange.

20. The device as claimed in claim 18, in which the blocking means can be actuated independently of the lock-up means.
